(19) United States
(12) Patent Application Publication
(10) Pub. No.: US 2024/0354078 A1
(43) Pub. Date: Oct. 24, 2024

(54) METHOD FOR PREPROCESSING CODE DATA FOR A SUBSEQUENT EVALUATION

(71) Applicant: Robert Bosch GmbH, Stuttgart (DE)

(72) Inventors: Jesko Hecking-Harbusch, Leonberg (DE); Jochen Quante, Ludwigsburg (DE); Matthias Woehrle, Bietigheim-Bissingen (DE); Maximilian Schlund, Boeblingen (DE)

(21) Appl. No.: 18/630,188

(22) Filed: Apr. 9, 2024

(30) Foreign Application Priority Data
Apr. 20, 2023 (DE) 10 2023 203 628.2

(51) Int. Cl. G06F 8/41

(52) U.S. Cl. CPC G06F 8/427

(57) ABSTRACT

A method for preprocessing code data for a subsequent evaluation, preferably for a safety-critical application. The method includes: providing a representation of the code data, wherein the representation has a multitude of paths, which specify different sequences of syntactic elements of a code of the code data; selecting a plurality of paths from the multitude of paths for the subsequent evaluation, wherein the paths are selected in a uniformly distributed manner, wherein a number of the selected paths is lower than a total number of the multitude of paths; carrying out a path calculation in which the selected paths are calculated, wherein the path calculation is limited to the selected paths; providing the calculated paths for the evaluation.

### CROSS REFERENCE

The present application claims the benefit under 35 U.S.C. § 119 of German Patent Application No. DE 10 2023 203 628.2 filed on Apr. 20, 2023 which is expressly incorporated herein by reference in its entirety.

### FIELD

The present invention relates to a method for preprocessing code data for a subsequent evaluation. The present invention furthermore relates to a computer program, a device, and a storage medium for this purpose.

### BACKGROUND INFORMATION

The preprocessing of code data can, for example, take place by parsing and subsequently extracting information from a parsed abstract syntax tree. This represents a common data wrangling task in the field of machine learning for code. For this purpose, it is often necessary to reduce the amount of data that is to be used later in training to a reasonable amount in order to make it suitable for the training.

### SUMMARY

An object of the present invention is a method, a computer program, a device, and a computer-readable storage medium. Features and example embodiment of the present invention can be found in the disclosure herein. Features and details which are described in connection with the method according to the present invention of course also apply in connection with the computer program according to the present invention, the device according to the present invention, and the computer-readable storage medium according to the present invention, and respectively vice versa, so that, with respect to the disclosure, mutual reference is or can be made to the individual aspects of the present invention at all times.

The subject matter of the present invention includes in particular a method for preprocessing code data for a subsequent evaluation, preferably for a safety-critical application. According to an example embodiment of the present invention, the following steps can be provided, which are preferably performed automatically and/or repeatedly and/or successively in the specified order:
providing a representation of the code data, wherein the representation can have a multitude of (in particular non-generated, uncalculated) paths, which specify different sequences of syntactic elements of a code of the code data;
selecting a plurality of paths from the multitude of paths for the subsequent evaluation, wherein the paths can be selected in a uniformly distributed manner, wherein a number of the selected paths can be lower than a total number of the multitude of paths, wherein the paths are preferably not yet calculated, in particular generated, before the selection;
carrying out a path calculation in which the selected paths can be calculated, preferably generated, wherein the path calculation can be limited to the selected paths;
providing the calculated paths for the evaluation, e.g., by generating embeddings on the basis of the calculated paths.

According to an example embodiment of the present invention, it is possible for the number of selected paths to be specified, wherein the specified number can be much smaller than the total number of paths in the representation. The total number can, for example, be very comprehensive as a result of the amount of code data. This is associated with the fact that the number of possible sequences of syntactic elements can be correspondingly high. In particular, the number of possible paths increases quadratically with the length. It may therefore be necessary that, for the subsequent evaluation, the set of paths to be evaluated must be reduced by the preprocessing. In particular, if the evaluation comprises machine learning, the selection of the paths for this reduction of the amount of training data is of great importance. By limiting the number of paths to be selected and the limitation of the path calculation to these selected paths, the paths can be selected in a uniformly distributed manner and calculated without having to calculate, in particular generate, the population of the paths. This can achieve the advantage that a time and space requirement for the preprocessing of large amounts of code data, which are present, for example, as abstract syntax trees or ASTs for short, can be significantly reduced without the subsequent evaluation being significantly impaired. This can lead to a significant reduction in the storage requirement in comparison to conventional solutions. A further positive effect is the faster preprocessing of the data since all data do not have to be generated first, if most of them are discarded later.

According to an example embodiment of the present invention, the code data can be designed as one or more source code data sets and/or source code. The code data can thus comprise a source code of a program. It is thus possible that the code data are represented by an AST. Within the scope of the present invention, the code data can also be referred to as a source code data set or source code.

Furthermore, within the scope of the present invention, it can be provided that the representation is designed as an abstract syntax tree in which the syntactic elements are provided as nodes. A portion of the nodes can be designed as leaves, which in particular form the terminal nodes of the syntax tree. In other words, the leaves can represent nodes that do not have any child nodes and thus represent an atomic unit in the program code, such as a variable. It is possible that only paths that are provided as a path between a pair of the leaves are selected from the multitude of paths for the subsequent evaluation. The multitude of paths may also, where appropriate, comprise only paths that are provided as a path between a pair of the leaves. Other paths between other nodes may not be taken into account in the selection and/or not counted for the total number. The paths can accordingly also be referred to as leaf pair paths. Where appropriate, not only the path but also the leaf pair in combination with the particular path is selected. A triple consisting of the path and the two leaves is thus selected, where appropriate.

An abstract syntax tree, AST for short, is in particular a structured representation of the syntactic structure of a program code. The AST can be constructed hierarchically and can comprise nodes representing components of the code. Furthermore, edges of the AST can be provided, which represent the relationships between the nodes. Each node can correspond to a syntactic element of the code, such as a variable, an operation or a control structure, and can contain information about the type and the properties of the element. The edges in the tree can specify the relationships between the nodes, such as the hierarchy of the control structure or the order of the operations. The abstract syntax tree can, for example, be derived from the source code of the program by means of a parser tool by parsing the code into a sequence of tokens and then analyzing the code using a grammar rule structure in order to identify the syntactic structure of the code and to construct the tree. For this purpose, there are various parser tools and technologies, such as Lex/Yacc, ANTLR or parser combinators, which can be used for the automated generation of abstract syntax trees.

Likewise, so-called leaves and paths can be provided in the abstract syntax tree. A leaf is in particular a node without a child node, i.e., a terminal node, which represents an atomic unit in the program code, such as a variable, a constant, or a function call. A path refers in particular to the sequence of nodes containing a specific path from the root of the tree to a specific node. A path can represent the sequence of the syntactic elements, in particular of the operations or control structures, in the code that result in a particular expression or result. Paths can therefore be used to identify and analyze specific parts of the code. Such a path is in particular referred to as a path between the leaves if it is located between two nodes which are both terminal nodes and thus do not have any child nodes. A path between the leaves typically represents an operation, an expression or an instruction in the code that consists of a sequence of elements, which are each represented by a node in the tree.

According to an example embodiment of the present invention, it may furthermore be possible that providing the calculated paths comprises: combining the calculated paths in an embedding, preferably by means of a machine learning model. [3], with the references in square brackets being specified at the end of the description, describes a method for assigning numerical vectors, so-called embeddings, to source code pieces. Embeddings can be obtained, for example, by converting discrete data into continuous vectors in order to capture their semantic similarities and to improve the performance of a model. In this case, the problem of embedding a function which is represented by its abstract syntax tree can be considered in the space of the real vectors so that “similar” functions appear close to one another. For this purpose, data extracted from the parsed source code of the function can be used to train a neural network model. For example, it is possible to take into account all pairs of leaves in the abstract syntax tree of the function and the (single) path that connects the two. If a function has an AST with l leaves, this results in

$$2 \cdot ( \begin{matrix}l \\ 2\end{matrix} )$$

possible triples of the form “(label of leaf 1, path, label of leaf 2),” which are referred to as a path context. The neural network model can then be trained for this task in order to predict a name of the function from a pocket of path contexts.

The performance of such a training method depends in particular on the size of the training data. In order to reduce this size as much as possible, and nevertheless to obtain an appropriately precise model, it can be provided that code contexts are examined at random. In conventional solutions (for example, https://github.com/AmeerHajAli/code2vec_c) a preprocessing phase is, for example, provided, in which all possible path contexts are first generated for each function, i.e., the population of the paths is calculated first, and a downsampling is then carried out in order to arrive at an appropriately small number (for example, 200) for each function under consideration (for example, as a standard feature, only those with at most 200 leaves). The AST of a function with 200 leaves results in 200*200=40000 possible contexts of which 200 (i.e., 0.5%) can be selected in order to compile the final preprocessed data, which are subsequently used during training. In practice, about 10% of the data can be retained during this sampling step. This factor of substantially 10 often separates the possible from the impossible: a preprocessing run that produces several terabytes of data quickly encounters storage space restrictions, while several hundred gigabytes may still be possible. According to the present invention, the amount of the generated data can therefore be significantly reduced during the preprocessing.

Furthermore, within the scope of the present invention, it is optionally possible that the evaluation is designed as an error analysis of the code data, and/or that the code data are designed for a safety-critical application, preferably for controlling an at least partially autonomous robot, preferably vehicle. Accordingly, the method according to the present invention can also be used in a robot or vehicle. The vehicle can, for example, be formed as a motor vehicle and/or passenger vehicle and/or autonomous vehicle. The vehicle can comprise a vehicle device, for example for providing an autonomous driving function and/or a driver assistance system. The vehicle device can be designed to at least partially automatically control and/or accelerate and/or brake and/or steer the vehicle.

Moreover, according to an example embodiment of the present invention, it is advantageous if the paths are selected in a uniformly distributed manner by carrying out a reservoir sampling, wherein the paths are preferably selected randomly from the multitude of paths. Reservoir sampling is in particular a method for the random and uniform selection of k elements from an unknown and potentially very large set of N elements. The reservoir is preferably constructed during the run through of the elements from the set, wherein each element is added with a certain probability to the reservoir and elements already contained in the reservoir can be replaced, where appropriate. At the end of the run, the reservoir can obtain a random and uniform selection of k elements from the original set without the entire set having to be completely run through first.

In addition, it is possible within the scope of the present invention that the paths are selected in a uniformly distributed manner by carrying out the following steps:
checking whether the total number is known;
if the check shows that the total number is known:
calculating a statistical uniform distribution, wherein the calculated uniform distribution is used for the selection of the paths;
otherwise: carrying out a reservoir sampling.

Alternatively or additionally, the total number of the multitude of paths can be at least 100 times or at least 1000 times greater than the number of the selected paths.

A further advantage within the scope of the present invention can be achieved if the path calculation comprises a calculation of the particular path on the basis of the sequence of the syntactic elements, wherein a result of the path calculation comprises a path representation for the particular calculated path and preferably a hash value for the particular path representation, wherein the result can be temporarily stored in a data memory, and the stored result can comprise only the path representations for the selected paths.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for data processing that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be carried out as a computer-implemented method.

Further advantages, features and details of the present invention can be found in the following description, in which exemplary embodiments of the present invention are described in detail with reference to the figures. The features disclosed herein can be essential to the present invention, individually or in any combination.

### BRIEF DESCRIPTION OF THE DRAWINGS

FIG. 1 is a schematic visualization of a method, a device, a storage medium and a computer program according to exemplary embodiments of the present invention.

FIG. 2 is a visualization of a syntax tree.

FIGS. 3 and 4 show different design variants of the present invention.

### DETAILED DESCRIPTION OF EXAMPLE EMBODIMENTS

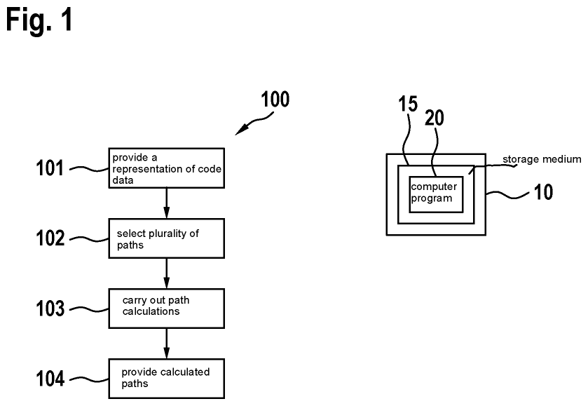

FIG. 1 schematically shows a method 100, a device 10, a storage medium 15, and a computer program 20 according to exemplary embodiments of the present invention. The method 100 serves for preprocessing code data for a subsequent evaluation, preferably for a safety-critical application.

According to a first method step 101, a representation 30 of the code data can be provided. In this case, the representation 30 can define a multitude of paths, which specify different sequences of syntactic elements 31 of a code of the code data. The representation 30 can, for example, be designed as a syntax tree 30, in which the syntactic elements 31 are provided as nodes 31, wherein preferably a portion of the nodes 31 are designed as leaves 32, which in particular form the terminal nodes 32 of the syntax tree 30. Within the scope of the present invention, the paths can, for example, denote all possible sequences or also only the sequences between leaves 32 of the representation 30, i.e., paths between leaves 32.

According to a second method step 102, a plurality of paths can be selected from the multitude of paths for the subsequent evaluation, preferably only those which form a path between a pair 201, 202 of the leaves 32 (leaf pair path). The paths can be selected in a uniformly distributed manner, wherein a number k of the selected paths can be lower than a total number N of the multitude of paths, in particular of the leaf pair paths.

Subsequently, according to a third method step 103, a path calculation can be carried out, in which the selected paths are calculated, wherein the path calculation is limited to the selected paths. In other words, a path calculation of the remaining, non-selected paths, possibly leaf pair paths, can be skipped. The path calculation can comprise a calculation of the particular path on the basis of the sequence of the syntactic elements 31, wherein a result of the path calculation can comprise a path representation for the particular calculated path and preferably a hash value for the particular path representation, wherein the result can be temporarily stored in a data memory 15.

According to a fourth method step 104, the calculated paths can be provided for the evaluation. The evaluation can, for example, be provided for error analysis in order to secure a safety-critical application, such as safety-critical control software.

In order to detect potential errors in software, the code can be analyzed statically (i.e., without execution) during the development. Static analysis tools report possible errors to a user and thus output an alarm. A plurality of cases can be distinguished here:

| | |
|---|---|
| Output of the | Real state |

| analysis | True | False |
|---|---|---|
| True | True positive | False positive |
| False | False negative | True negative |

False negatives are overlooked errors, and techniques like abstract interpretation can guarantee that their number is 0 (such tools are called solid). On the other hand, they often report a high number of false positives (i.e., false alarms). It is mathematically impossible (cf. the halting problem and Rice's theorem) to achieve all three objectives at the same time: 0 false positives, 0 false negatives, and a fully automatic analysis. For safety-critical software, false-negative results are of particular concern, which is why standards like ISO26262 [1] recommend a static code analysis and in particular an analysis by means of abstract interpretation. Examples of safety-critical control software in the automotive sector are, for example, engine control or inverter control, ESP, windshield wiper, airbag or steering. Software can also be critical outside the automotive sector. For example, software for controlling a cooktop (household appliance) can be safety critical. Alarms that are reported by static analysis tools (in particular those of the “sound” type) are predominantly false positive (for example, >99%) so that a human tester can benefit from an automatic prioritization of the alarms.

One strategy can be the use of machine learning (ML) for the post-processing of such alarms (cf. [2]). However, in order to use this strategy effectively, the code must be made suitable for ML methods by a preprocessing. ML methods can be supplied with source code by converting the source code into numerical vectors (“embedding”), and this embedding can be learned a priori.

In addition to the application for a post-processing of alarms of the static analysis, code embeddings (i.e., the conversion of code into vectors) have further advantages. For example, such embeddings can be used to calculate the similarity of code snippets that can be used for clustering source code, which may be helpful in understanding the program.

According to exemplary embodiments of the present invention, a preprocessing can, for example, make use of randomly selected path sets from code parsed in ASTs, and can be adapted such that the paths of interest are scanned online, instead of generating the set of all paths of interest (path enumeration, i.e., in particular the identification of relevant paths in the tree that capture the semantic properties of the code, and the extraction of these paths as separate tree structures) and then carrying out a downsampling (reduction of the number of nodes in the tree by combining node groups which represent semantically similar operations or expressions).

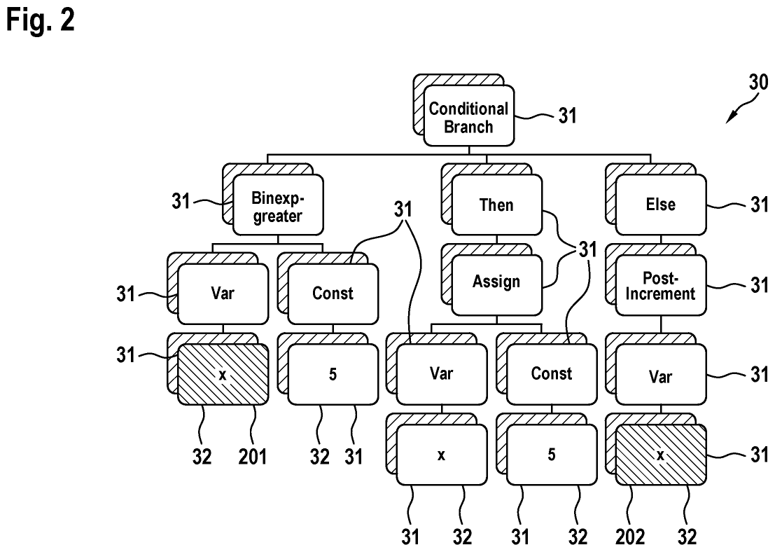

In FIG. 2, a very simple AST 30 for the code fragment “if (x>5) {x=5;} else {x++;}” is shown by way of example. This AST 30 has leaves 32, and each leaf pair defines a unique path; for example, the path from the far left “x” 201 to the far right “x” 202 is described by the sequence of nodes 31 and movements: upward (“Λ”) or downward (“v”): (x, Λ, Var, Λ, Binexp-greater, Λ, Conditional branch, v, Else, v, Post-increment, v, Var, v, x). Since each node pair defines a path that can be run through back and forth, there are

$$2 \cdot ( \begin{matrix}n \\ 2\end{matrix} ) = n \cdot ( n - 1 )$$

paths for n leaves 32. In this example, this results in 20 paths. For each of these paths, a costly path calculation may have to be carried out if this path is selected (for example, for code2vec [3], for two leaf nodes, first the path which connects them and then a hash value of the path representation must be calculated).

A downstream task (for example, the training of a code embedding model) rarely needs the entire (very large) set of paths of size N, but rather often only a random sample therefrom of size k<<N (for example, k can be in the range of 100-1000, while N can be in the range of 10000-100000). If N cannot be known a priori (for example, because not all paths are simply to be considered, but only a subset of paths “of interest” that cannot be described a priori), it is proposed that the paths are captured online using the standard technique of reservoir sampling (cf. [4] and [5]). In doing so, a reservoir of constant size k is maintained during the enumeration of the paths, and immediately when a path is taken into consideration, a decision can be made as to whether it is added to the reservoir (this could be a path that is currently in the reservoir) or whether it will be discarded forever. In this way, only a constant number of paths needs to be kept in the memory at any time, and only the calculations for the paths that are added during the sampling have to be carried out. On the other hand, if N is known, reservoir sampling does not even need to be used, but k (ordered) pairs from the set (of the indices) of the leaves can simply be selected, i.e., k pairs (without repetition) can be selected from {0, . . . , N−1}, and the calculations are carried out only for the paths that connect them. This requires some calculations (for example, the calculation of the path from its leaf end points or in the case of code2vec: hashing of the resulting path).

The idea of blending the path enumeration and the sampling can be expanded even further beyond the preprocessing phase so that preprocessing and training effectively fuse. Since the sampling (for example, by means of reservoir sampling) is quite fast, the data can be newly sampled several times during the training (for example, after several epochs) in order to train a more robust model instead of training on a static data set from the preprocessing. Moreover, during the inference, an AST can be obtained and a task can be fulfilled (for example, summarizing the underlying code in a single word, i.e., predicting function names as in [3]). For this purpose, a sampling of paths from this AST can be input into the trained model in order to obtain a prediction. Since the sampling of paths with the proposed method according to exemplary embodiments of the present invention can be carried out efficiently, it can be provided that a plurality of samples are obtained and a prediction is made for each of them. In this way, an uncertainty estimation can be created with exemplary embodiments of the present invention, and predictions that fluctuate greatly can be ignored.

According to design variants of the present invention, the online sampling and the path enumeration can be combined with one another. Path enumeration and downsampling are techniques that can be used to reduce the size of abstract syntax trees and thus to improve the efficiency of code analysis methods. Path enumeration refers in particular to the identification of relevant paths in the AST that capture the semantic properties of the code, and the extraction of these paths as separate tree structures. This can, for example, take place by identifying paths between important nodes, such as function calls or loops. Downsampling refers in particular to the reduction in the number of nodes in the AST by combining node groups that represent semantically similar operations or expressions. This can, for example, take place by grouping similar variable declarations or assignments.

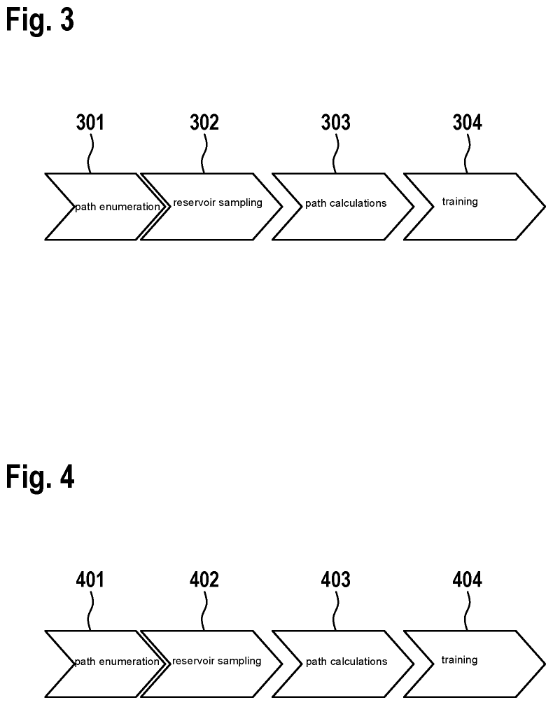

FIG. 3 shows a first situation, in which N is unknown. In this case, a path enumeration 301 and a reservoir sampling 302 can be carried out first. The subsequent path calculations 303 are then applied only to the sampled paths. Subsequently, the training 304 can take place.

FIG. 4 shows a second situation, in which N is known. In this case, a path enumeration 401 and a sampling 402 of (pairs of) leaves can be carried out first. Subsequent path calculations 403 are then applied only to the sampled paths. Subsequently, the training 404 can take place.

The above description of the embodiments describes the present invention exclusively in the context of examples. Of course, individual features of the embodiments, provided they make technical sense, can be freely combined with one another without departing from the scope of the preference invention.

### REFERENCES

[1] ISO 26262-6, Road vehicles-Functional safety, Part 6: Product development at the software level, 2018.
[2] A. Kharkar, R. Z. Moghaddam, M. Jin, X. Liu, X. Shi, C. Clement and N. Sundaresan, “Learning to reduce false positives in analytic bug detectors,” Proceedings of the 44th International Conference on Software Engineering (ICSE '22), 2022.
[3] Uri Alon, Meital Zilberstein, Omer Levy, and Eran Yahav. 2019. Code2vec: learning distributed representations of code. Proc. ACM Program. Lang. 3, POPL, Article 40 (January 2019), 29 pages. https://doi.org/10.1145/3290353
[4] Jeffrey S. Vitter. 1985. Random sampling with a reservoir. ACM Trans. Math. Softw. 11, 1 (March 1985), 37-57. https://doi.org/10.1145/3147.3165
[5] Kim-Hung Li. 1994. Reservoir-sampling algorithms of time complexity O (n (1+log (N/n))). ACM Trans. Math. Software. 20, 4 (December 1994), 481-493. https://doi.org/10.1145/198429.198435

What is claimed is:

1. A method for preprocessing code data for a subsequent evaluation, comprising the following steps:
providing a representation of the code data, wherein the representation has a multitude of paths, which specify different sequences of syntactic elements of a code of the code data;
selecting a plurality of paths from the multitude of paths for the subsequent evaluation, wherein the paths are selected in a uniformly distributed manner, wherein a number of the selected paths is lower than a total number of the multitude of paths;
carrying out a path calculation in which the selected paths are calculated, wherein the path calculation is limited to the selected paths; and
providing the calculated paths for the evaluation.

2. The method according to claim 1, wherein the code data is for a safety-critical application.

3. The method according to claim 1, wherein the representation is configured as an abstract syntax tree in which the syntactic elements are provided as nodes, wherein a portion of the nodes are configured as leaves, which form terminal nodes of the syntax tree, wherein only paths provided as a path between a pair of the leaves are selected from the multitude of paths for the subsequent evaluation, and the multitude of paths includes only selected paths, wherein each leaf pair is also selected in combination with the particular path in the form of a triple.

4. The method according to claim 1, wherein the evaluation is configured as an error analysis of the code data, wherein the code data are configured for a safety-critical application for controlling an at least partially autonomous robot or vehicle.

5. The method according to claim 1, wherein the paths are selected in a uniformly distributed manner in that a reservoir sampling is carried out, wherein the paths are selected randomly from the multitude of paths.

6. The method according to claim 1, wherein the paths are selected in a uniformly distributed manner in that the following steps are carried out:
checking whether the total number of the multitude of paths is known;
calculating a statistical uniform distribution when the check has shown that total number is known, wherein the calculated uniform distribution is used for the selection of the paths, and otherwise carrying out a reservoir sampling,
wherein the total number of the multitude of paths is at least 100 times greater than the number of the selected paths.

7. The method according to claim 1, wherein the providing of the calculated paths includes:
combining the calculated paths in an embedding, using a machine learning model.

8. The method according to claim 1, wherein the path calculation includes a calculation of each particular path on based on a sequence of the syntactic elements, wherein a result of the path calculation includes a path representation for the particular calculated path and a hash value for the particular path representation, wherein a result is temporarily stored in a data memory, and the stored result includes only the path representations for the selected paths.

9. A device for data processing that is configured for preprocessing code data for a subsequent evaluation, the device configured to:
provide a representation of the code data, wherein the representation has a multitude of paths, which specify different sequences of syntactic elements of a code of the code data;
select a plurality of paths from the multitude of paths for the subsequent evaluation, wherein the paths are selected in a uniformly distributed manner, wherein a number of the selected paths is lower than a total number of the multitude of paths;
carry out a path calculation in which the selected paths are calculated, wherein the path calculation is limited to the selected paths; and
provide the calculated paths for the evaluation.

10. A non-transitory computer-readable storage medium on which are stored commands for preprocessing code data for a subsequent evaluation, the commands, when executed by a computer, causing the computer to perform the following steps:
providing a representation of the code data, wherein the representation has a multitude of paths, which specify different sequences of syntactic elements of a code of the code data;
selecting a plurality of paths from the multitude of paths for the subsequent evaluation, wherein the paths are selected in a uniformly distributed manner, wherein a number of the selected paths is lower than a total number of the multitude of paths;
carrying out a path calculation in which the selected paths are calculated, wherein the path calculation is limited to the selected paths; and
providing the calculated paths for the evaluation.
